(19) United States
(12) Patent Application Publication
(10) Pub. No.: US 2022/0382741 A1
(43) Pub. Date: Dec. 1, 2022

(54) GRAPH EMBEDDINGS VIA NODE-PROPERTY-AWARE FAST RANDOM PROJECTION

(71) Applicant: Neo4j Sweden AB, San Mateo, CA (US)

(72) Inventor: Jacob Sznajdman, Gothenburg (SE)

(21) Appl. No.: 17/334,222

(22) Filed: May 28, 2021

(51) Int. Cl. G06F 16/23; G06F 16/901

(52) U.S. Cl. CPC G06F 16/2379; G06F 16/9024

(57) ABSTRACT

Techniques are disclosed to generate graph embeddings via node-property-aware fast random projection. In various embodiments, graph data comprising a plurality of nodes, each of at least a subset of nodes having associated therewith a set of one or more node property values each for a corresponding node property, is stored. For each node in at least said subset of nodes, an initial vector is generated based at least in part on the set of one or more node property values. The initial vectors are used to generate for each node in at least said subset of nodes an embedding.

### BACKGROUND OF THE INVENTION

A graph database is a computerized record management system that uses a network structure with nodes, edges, labels, and properties to represent data. A node may represent an entity such as a person, a business, an organization, or an account. Each node has zero or more labels that declare its role(s) in the network, for example as a customer or a product. Nodes have zero or more properties which contain user data. For example, if a node represents a person, the properties associated with that node may be the person's first name, last name, and age. Relationships connect nodes to create high fidelity data models. Relationships are directed, have a type which indicates their purpose and may also have associated property data (such as weightings).

Graph databases have various applications. For example, a graph database may be used in healthcare management, retail recommendations, transport, power grids, integrated circuit design, fraud prevention, and a social network system, to name a few.

Contemporary machine learning (ML) software creates a model by ingesting feature vectors from some input data. The feature vectors contain numerical values representing aspects of some domain. For example, for a human population the vectors might contain numerical representations of gender, residence, age, politics, educational level and so forth. With these vectors and a list of target values, the ML software can train a model (often just compute a function) which best fits the supplied vectors and their associated target values. The trained model can then be used to predict future values, for example if given a person's age, residence, and education level, the trained model might be able to predict, somewhat accurately, their political persuasion.

It is well understood that the predictive power of machine learning models depends strongly on using informative features. However, there is a limit to the information contained in features that are easily mined from common row-, document-, or column-structured databases. Only the data values given by the schema (whether it is explicit or implicit) can be mined.

Graph databases store not only data values as other database types have, but also the connected network between those values. This opens the possibility for richer features to be extracted which can then be used to enhance the machine learning model. For one skilled in the art of graph theory, it is apparent that metrics like node degree, centrality, Page Rank, neighborhood, similarity, and so forth can be encoded as part of feature vectors and used to create models which have better outcomes.

In recent years, Graph Embeddings, which map graph nodes into a vector space, have been an active area of work and numerous algorithms and software libraries have been produced. Graph Embeddings can encode various important topological information in the vectors, such as neighborhood structure, community affiliation, a node's role in the network, or any other network topology. The vectors produced by Graph Embeddings have proven to yield high quality features for machine learning models and highly reduce the need of manual feature engineering.

However, using features based only on graph topology and ignoring tabular information like node properties can be limiting. The strongest predictive performance can in general only be achieved by using both kinds of features and features that depend on graph topology and tabular information simultaneously.

### BRIEF DESCRIPTION OF THE DRAWINGS

Various embodiments of the invention are disclosed in the following detailed description and the accompanying drawings.

FIG. 1A is a block diagram illustrating an embodiment of a graph database system configured to generate and use graph embeddings via node property-aware fast random projection.

FIG. 1B is a flow diagram illustrating an embodiment of a process to generate and use graph embeddings via node property-aware fast random projection.

FIG. 2A is a flow diagram illustrating an embodiment of a process to generate and use graph embeddings via node property-aware fast random projection.

FIG. 2B is a flow diagram illustrating an embodiment of a process to initialize vectors to create graph embeddings via node property-aware fast random projection.

FIG. 3 is a diagram illustrating an example of generating graph embeddings via fast random projection in an embodiment of a graph database system.

FIG. 4 is a diagram illustrating an embodiment of a process to generate node property-aware graph embeddings in an embodiment of a graph database system.

FIG. 5 is a diagram illustrating an embodiment of a graph database system configured to embed multiple graphs into a same vector space via inductive embedding.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques are disclosed to generate graph embeddings via node-property-aware fast random projection. In various embodiments, node property data is incorporated into random projection-based graph embedding software to provide better quality feature vectors. In various embodiments, software to implement techniques disclosed herein to generate node-property-aware graph embeddings executes quickly and scales to large graphs.

In various embodiments, node embeddings are created from graphs for machine learning and operating using random projection techniques, which scale well with graph size. The quality of the node embeddings is improved, with respect to their use in machine learning, by combining node properties along with graph topology. In some embodiments, a pure graph topology-based component is included in the embeddings. In some embodiments, as a special case, an inductive graph embedding algorithm is provided.

Graphs increasingly are used as the input to machine learning (ML) tasks, but traditionally the graph data that fuels the machine learning algorithms has been limited to graph topology, e.g., which nodes are adjacent to which other nodes. Techniques are disclosed to incorporated additional information available in graph databases, such as node property data, into machine learning processes. Including such information for processing by machine learning systems, in various embodiments, provides better outcomes (higher quality predictions) from those machine-learned models. In various embodiments, graph embeddings created for machine learning are generated in a manner, as disclosed herein, that takes into account not only the structural context of the graph but also the data that nodes in the graph contain (their properties).

In various embodiments, avoiding the use of node identities and relying solely on node properties enables other graphs with the same properties to be embedded into the same vector space so that nodes from different graphs, or an evolving graph, can be meaningfully compared to each other. This is known as inductive graph embeddings. In various embodiments, a novel inductive embedding based on random projection can be used as disclosed herein to first generate training data based on one or more graphs which is used to train a predictive model and subsequently on other graphs to produce features which are fed into the model to yield predictions.

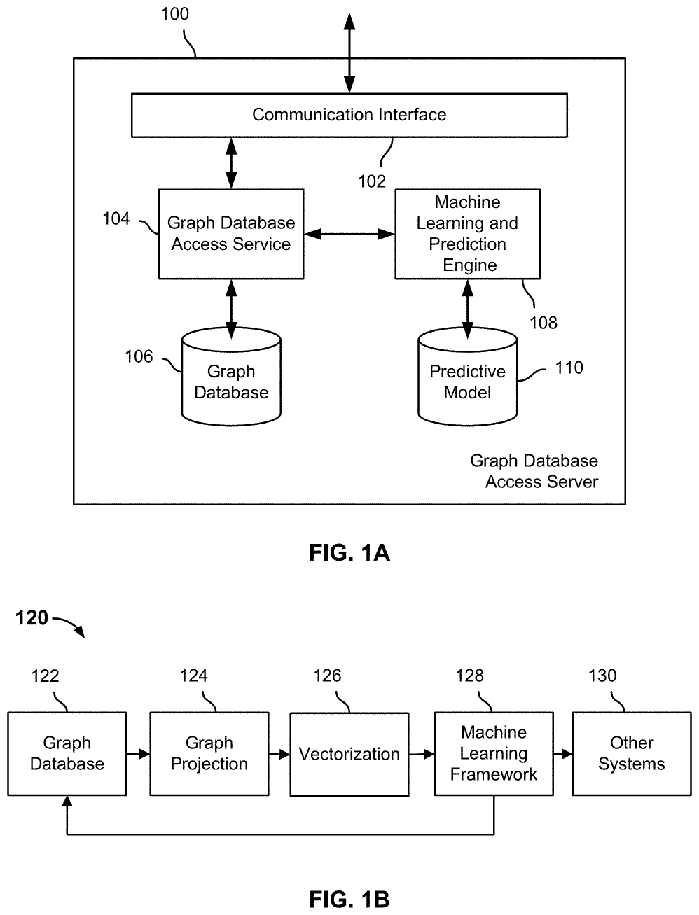

FIG. 1A is a block diagram illustrating an embodiment of a graph database system configured to generate and use graph embeddings via node property-aware fast random projection. In the example shown, graph database access server 100 include a communication interface 102, such as a network interface card or other network interface. In various embodiments, graph database access server 100 may be accessed by one or more client systems, not shown in FIG. 1A, via network communications received via communication interface 102. For example, requests may be sent via communication interface 102 to graph database access service 104, e.g., to read, write, delete, or otherwise access data stored in a graph database 106. Examples of graph database 106 include, without limitation, a Neo4jTM or other graph database.

In various embodiments, graph database access service 104 and/or another module or software entity is configured to generate graph embeddings as disclosed herein. For example, in some embodiments graph database access service 104 accesses and uses data read from a graph store in graph database 106 to generate graph embedding for at least a subset of nodes comprising the graph. In some embodiments, the embeddings are stored in graph database 106, e.g., each embedding being stored as a property of the corresponding node. The graph embeddings are generated, in various embodiments, via node property-aware fast random projection, as disclosed herein.

In various embodiments, machine learning and prediction engine 108 accesses via graph database access service 104 graph embeddings stored in graph database 106 and uses the embedding to generate via machine learning techniques and store in predictive model store 110 a predictive model. In various embodiments, the machine learning and prediction engine 108 is configured to use the model generated based on the graph embeddings to make a prediction. For example, machine learning and prediction engine 108 in some embodiments uses the model to generate a prediction based on a feature vector provided as input, such as a feature vector associated with a node in a graph based on which the model was generated or a node in a graph having the same (or similar/compatible) relevant properties and/or topology as the graph based on which the model was generated.

FIG. 1B is a flow diagram illustrating an embodiment of a process to generate and use graph embeddings via node property-aware fast random projection. In various embodiments, the pipeline 120 of FIG. 1B is implemented at least in part by a graph database access server, such as server 100 of FIG. 1A. In various embodiments, graph embeddings generated via node property-aware fast random projection, as disclosed herein, are generated as part of a broader system of computing equipment which forms a processing pipeline such as pipeline 120 of FIG. 1B.

In the example shown, a graph projection 124 from graph database 122 is provided as input to a vectorization process and/or module 126. In some embodiments, an expert user runs a query on the graph database 122 to project a graph 124 whose structure and data are to be projected, which may include the entirety of the graph or any other desired mapping. In some embodiments, the expert specifies the property keys of nodes in the graph which will be processed.

The projection 124 is fed into vectorization process/module 126, which creates vectors suitable for consumption by machine learning (ML) framework 128. The ML framework 128 learns the structure and properties of the graph and produces a trained model as its output. The model may be used by other downstream systems 130 (such as user-facing applications) or may be used to enrich the original graph model (122) from which the data was projected.

In various embodiments, the vectorization process/module 126 generates embeddings via node property-aware fast random projection, as disclosed herein. In various embodiments, the vectorization 126 of the projected graph 124 is partially based on the Fast Random Projection or “FastRP” algorithm, combined with node property-aware components as disclosed herein, which in various embodiments provides significantly improved quality input data for the ML framework 128 and hence improved models.

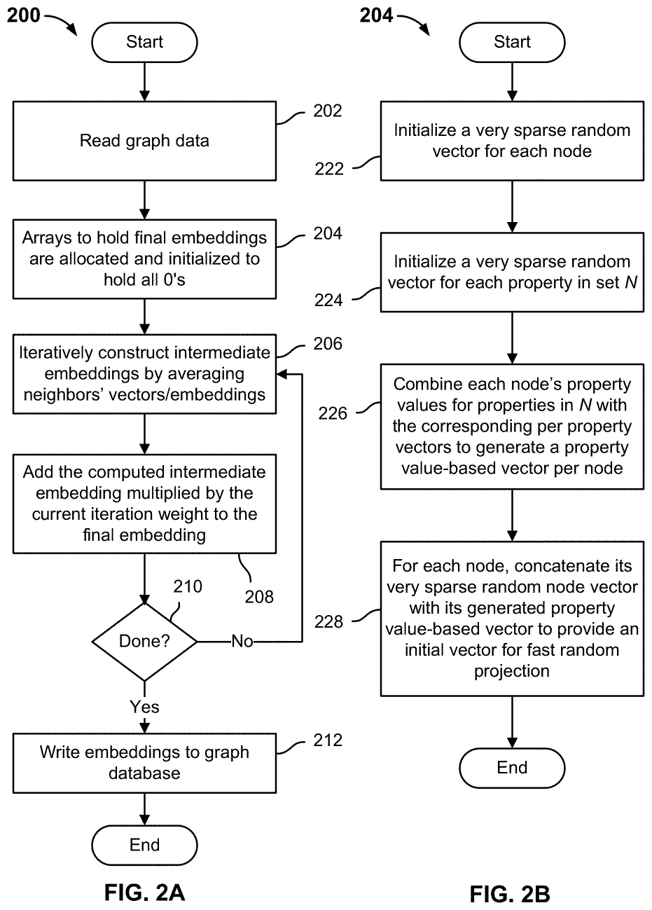

FIG. 2A is a flow diagram illustrating an embodiment of a process to generate and use graph embeddings via node property-aware fast random projection. In various embodiments, the process 200 of FIG. 2A is implemented by a graph database access server, such as server 100 of FIG. 1A. In the example shown, at 202 graph data is read from the graph database. At 204 arrays holding the final embeddings are allocated and initialized to hold all 0's. In various embodiments, the initial vectors include a randomly generated component based on a graph topology and a node property-aware component based on one or more node property values and graph topology. At 206, intermediate embeddings are constructed for each node by averaging the current (e.g., initial or intermediate) embeddings of neighboring nodes. If at 208 it is determined that a further iteration is required, e.g., a prescribed or configured number of iterations has not yet been reach, then at 206 a further iteration of averaging each nodes neighbors' embeddings is performed. At 208, the computed intermediate embedding multiplied by the current iteration weight to the final embedding. Once the final iteration is completed (210), the final embeddings are written to the graph database (or other storage/destination) at 212.

FIG. 2B is a flow diagram illustrating an embodiment of a process to initialize vectors to create graph embeddings via node property-aware fast random projection. In various embodiments, the process of FIG. 2B is performed to implement step 204 of the process 200 of FIG. 2A. In the example shown, at 222 a very sparse random vector is initialized for each node. At 224, a very sparse random vector is initialized for each property in a set N comprising n properties each of which is to be reflected in the embeddings. At 226, for each node the node's property values for the properties in set N are combined with the corresponding per-property very sparse random vectors to generate a property value-based vector component for each node. At 228, for each node, the very sparse random node vector generated at 222 is concatenated with its property value-based vector component as generated at 226 to provide for the node an initial vector to be used as input to the next phase of the fast random projection algorithm, e.g., steps 206 and 208 of FIG. 2A.

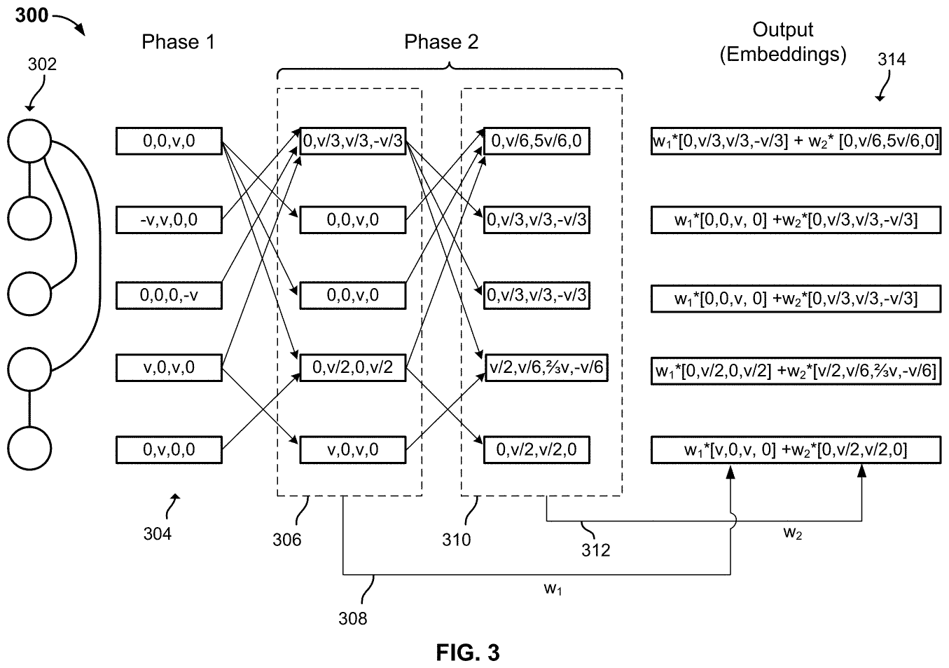

FIG. 3 is a diagram illustrating an example of generating graph embeddings via fast random projection in an embodiment of a graph database system. In various embodiments, the example vectors (embeddings) as shown in FIG. 3 are generated by a graph database access server, such as server 100 of FIG. 1A.

The example 300 of FIG. 3 illustrates the three logical phases of the FastRP algorithm: initialization (Phase 1), which is random in the prior approach but lacks the node property-aware component in techniques as disclosed herein; iterative averaging and normalization of neighbor intermediate embeddings (Phase 2); and final creation of vectors (Output/Embeddings). In practice, the third logical phase typically is carried out during the second phase by at the end of each iteration updating the final vectors displayed on the right of FIG. 3.

In the prior approach, initially FastRP creates a random sparse vector (e.g., 304) for each node in the graph (e.g., 302). The technique to generate these vectors, in various embodiments, is Very Sparse Random Projections. For a number of iterations (chosen by the expert user, for example) a current and a previous vector is maintained for each node. During each iteration FastRP will for each node find the neighboring nodes and average their previous vectors into the current node's current vector, before normalizing the current vector's values. See, e.g., the first iteration vectors 306, computed for each node based on its neighbors, represented in FIG. 3 by the arrows from vectors 304 to vectors 306; and the second iteration vectors 310, computed for each node based on its neighbors, represented in FIG. 3 by the arrows from vectors 306 to vectors 310. Finally, for the iteration, the previous vectors are updated to the current ones for each node. During the first iteration, the previous vectors are the initial vectors from the first phase, e.g., vectors 304. Once all iterations are complete the final set of vectors are ready, e.g., output/embeddings 314 in the example 300 shown in FIG. 3.

As shown in FIG. 3, in various embodiments the results each iteration of Phase 2 (vectors 306, 310) may be reflected in the final output (314) in a manner that reflects a weight assigned for that iteration, e.g., weight w1 (308) for the first iteration (306) and weight w2 (312) for the second iteration (310) in the example shown in FIG. 3.

The randomness injected in the first phase of FastRP is supported by a piece of theoretical computer science based on the Johnsson-Lindenstrauss lemma. However, the present disclosure, in various embodiments, improves upon FastRP by including node properties into the initial vectors to provide higher-quality output than would otherwise be achieved.

In various embodiments, the node-property-aware method as disclosed herein uses a mixture of pure graph topology-based embedding arising from random sparse vectors aggregated iteratively over neighborhoods like in FastRP on one hand, and on the other hand also node-property-aware embedding obtained by iteratively aggregating both neighbouring nodes' property values and random sparse vectors associated to properties . In various embodiments, a portion of the embedding vector's elements consist of purely topological features and the remainder consist of node-property-aware features.

In various embodiments, the inputs to the node property-aware fast random projection process/module as disclosed herein include a directed or undirected property graph, a set of node properties to be used, and several algorithmic settings, such as the number of elements in the two portions of the embedding vectors. The outputs are the embedding vectors associated with the nodes of the graph. In various embodiments, processing starts by generating random sparse vectors per node (like FastRP) and random sparse vectors per property. In various embodiments, the method to sample the latter vectors is the Very Sparse Random Projections technique mentioned above (which is also used in FastRP).

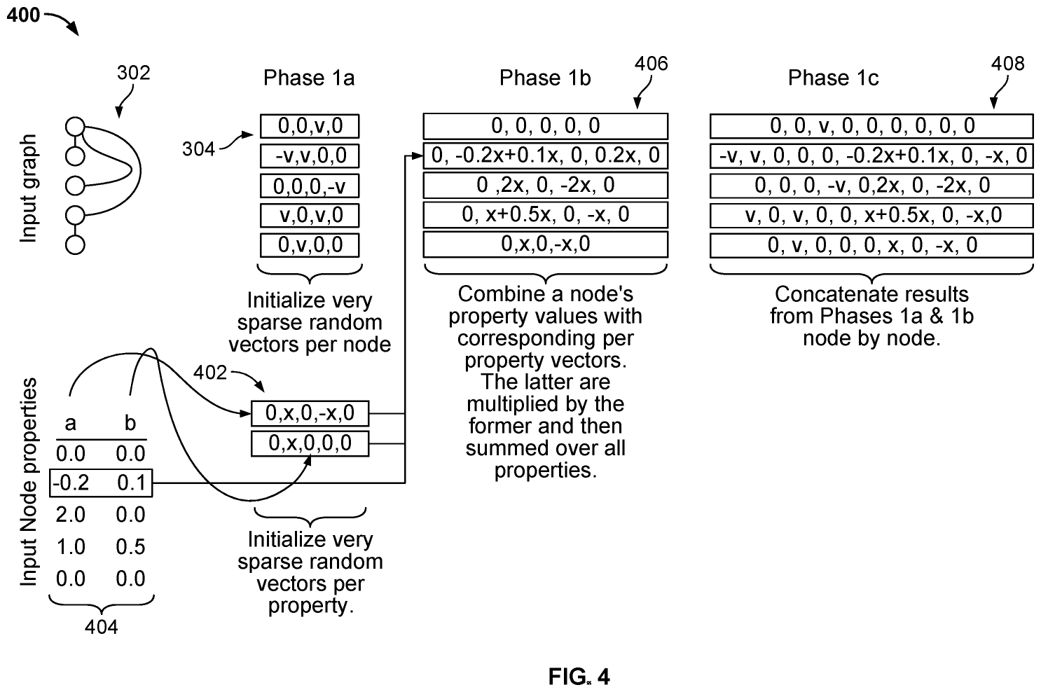

FIG. 4 is a diagram illustrating an embodiment of a process to generate node property-aware graph embeddings in an embodiment of a graph database system. In the example 400 shown in FIG. 4, the first phase of the Fast Random Projection (FastRP) processing identified as “Phase 1” in FIG. 3 is replaced by three subphases 1a, 1b, and 1c to produce output vectors 408, which play the same role as the initial vectors 304 of FIG. 3 and which in various embodiments are provided as input to the subsequent processing, identified as “Phase 2” in FIG. 3, to produce the output vectors/embeddings to be used for machine learning.

In the example shown in FIG. 4, two node properties have been specified by the expert, a and b, and therefore there are two random sparse vectors 402 created for those properties. In various embodiments, there may be more properties of interest defined by the expert in their graph projection. If the number of properties is very small, the random generation of the per-property vectors can be replaced by a deterministic one hot encoding, that is, the vector for the i:th property has a value of 1 in its i:th position and a value of zero in all other positions.

Next, for each node the node property data for the expert-designated node properties, e.g., 404, is combined with the corresponding random sparse vectors 402 to produce combined vectors 406. In the example shown, for each node the two sparse random vectors 402 that were created for each node property are multiplied by the corresponding property values of the node before summing these two vectors. As shown for the second node in graph 302, for example, the vector in 402 that is associated with property a (upper vector) is multiplied by the actual value of node property a for the second node, and the vector 402 associated with property b (lower vector) is multiplied by the value of node property b for the same node, before these two scaled vectors are added together. In numbers this means: −0.2*[0, x, 0, −x, 0]+0.1*[0, x, 0, 0, 0]=[0, −0.2x, 0, 0.2x, 0]+[0, 0.1x, 0,0,0]=[0, −0.1x, 0, 0.2x, 0]. In general, for each node the sum of vectors (e.g., 406) is obtained by, for each property, taking the sparse random vector associated with that property and multiplying it with the value of the same property for that node and summing the results across properties for that node.

As shown in FIG. 4, the topology-based sparse random vectors per node from Phase 1a (304) are concatenated with the blended property-aware vectors per node created in Phase 1b (406) to generate node property-aware initial vectors 408.

Other approaches to creating node property-aware initial vectors include:
1) Assign a neural network to map the properties to a property vector; along the lines of the graphSAGE approach.
2) Applying principal component analysis/SVD/other matrix factorization technique to obtain per-property vectors.
3) Spreading out per-property vectors uniformly on a sphere and (optionally) applying sparsification afterwards.

Once the concatenated vectors 408 have been computed, processing continues as in the FastRP algorithm in that a node's vector is computed iteratively by averaging its neighbors' vectors for some number of iterations specified by an expert. In other words, Phase 1 in FastRP as shown in FIG. 3 is replaced by Phases 1a, 1b, and 1c as shown in FIG. 4.

In various embodiments, the vectors resulting from generating node property-aware initial vectors 408 as in FIG. 4 and providing them as input to perform FastRP Phase 2 processing as illustrated in FIG. 3 are transmitted to a machine learning system to train a predictive model.

In various embodiments, additional processing required to generate node-property aware initial vectors for fast random projection, as disclosed herein, is linear with respect to the input graph size and so will scale for many useful scenarios.

In various embodiments, one or more parameters (sometimes referred to as “hyperparameters” are set, e.g., by an expert, to configure or tune generating of graph embeddings via node property-aware fast random projection as disclosed herein. For example, an administrative user interface, a configured file, or another configuration data and/or user interface may be used to set the parameters. Examples of the numerical parameters include without limitation, one or more of the following: input graph g; names or references to properties to be reflected in the embeddings P; normalization strengths β; sparsity s, e.g., of initial random vectors; iteration weights ws (e.g., w₁ and w₂ in FIG. 3); topological embedding dimension dₙ (e.g, length of per-node initial random vectors); and property-aware embedding dimension dₚ (e.g., length of property-aware initial random vectors).

While in the approach shown in FIG. 4 node property-based components (e.g., 406) are combined with topology-based components (e.g., 304) by concatenation, in various embodiments node property-based components are combined with topology-based components in ways other than and/or in addition to concatenation, e.g., without limitation on or more of interleaving values from the two vectors, or pooling them together in a different way, or interspersing a few random components amongst the elements of the node property-based components.

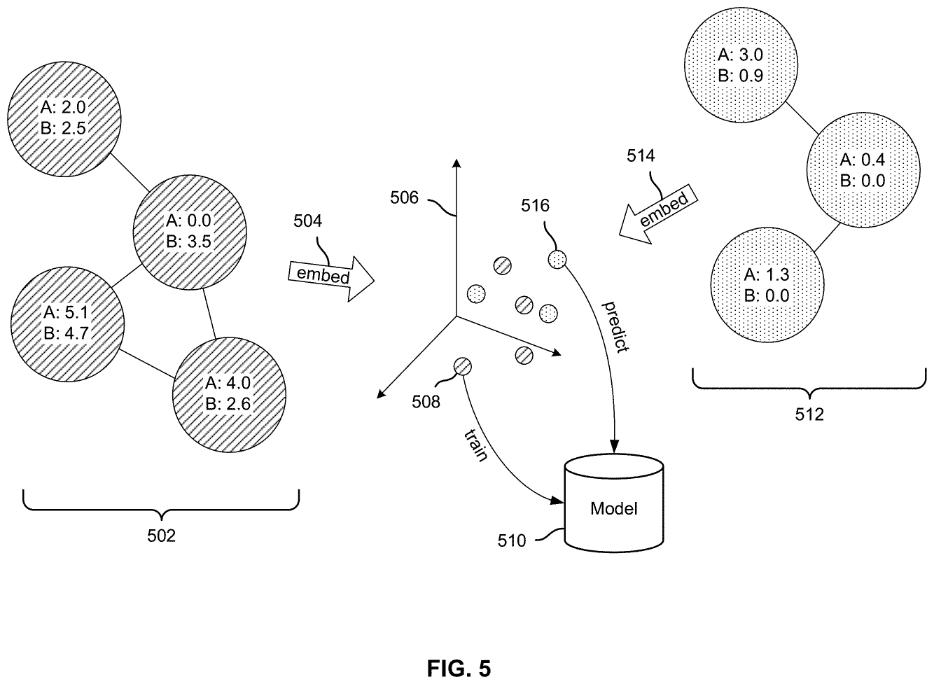

FIG. 5 is a diagram illustrating an embodiment of a graph database system configured to embed multiple graphs into a same vector space via inductive embedding. In various embodiments, the initial per-node vectors (e.g., vectors 304 in FIG. 4) have zero length, in which the entire embeddings are property-aware (e.g., 406 and 408 are the same). In this case node identities are not used as features and are therefore anonymized by the embedding. Nevertheless, embeddings still encode both property and topology information, as a result of the iterative averaging of neighbors in Phase 2 of the FastRP processing. A property graph isomorphism is a 1-1 mapping between graphs that preserves edges and properties. In the special case above, two nodes will have identical embedding vectors if their extended neighborhoods required for their embeddings are isomorphic as property graphs. Moreover, nodes with similar extended neighborhoods have similar embeddings. This enables other graphs with the same properties (e.g., 502, 512) to be embedded into the same vector space (e.g., 506) so that nodes from different graphs, or an evolving graph, can be meaningfully compared to each other. Such embeddings are known as inductive graph embeddings, as illustrated in the example shown in FIG. 5.

In the example shown in FIG. 5, a first graph (or graph projection) 502 is embedded/projected (504) into a vector space 506, e.g., via node property-aware fast random projection, as disclosed herein. The resulting embeddings (e.g., 508) are used to train a machine learning model 510. A second graph (or graph projection) 512 having the same node properties (and/or, in some embodiments, topology) is embedded/projected (514) into the same vector space 506. Feature vectors comprising and/or derived from the resulting embeddings (e.g., 516) may be used, in this example, to generate a prediction based on the same model 510 that was generated based on graph 502.

A novel inductive embedding based on random projection rather than neural networks is disclosed. To achieve inductive embeddings, in various embodiments, the per node property vectors (e.g., vectors 402 of FIG. 4) are saved for later use after being constructed. When embedding a new graph inductively, the per property vectors are then retrieved and loaded instead of being sampled anew.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a memory configured to store graph data comprising a plurality of nodes, each of at least a subset of nodes having associated therewith a set of one or more node property values, wherein each node represents an entity and each of the one or more node property values includes information about the entity of a corresponding node; and
a processor coupled to the memory and configured to:
generate for each node in at least said subset of nodes an initial vector based at least in part on the set of one or more node property values; and
use the initial vectors to generate, for each node in at least said subset of nodes, an embedding, wherein the embedding encodes information about the corresponding node in a vector.

2. The system of claim 1, wherein the initial vector includes a topology-based component and a node property-based component.

3. The system of claim 2, wherein the topology-based component comprises a very sparse random vector and the very sparse random vector is generated by sampling random sparse vectors per property.

4. The system of claim 2, wherein the node property-based component is constructed at least in part by initializing a very sparse random vector for each node property corresponding to said one or more node property values; and, for each node, combining the very sparse random vector initialized for each property with the corresponding node property values for the node.

5. The system of claim 4, wherein combining includes for each property multiplying the per property very sparse random vector by the corresponding node property value for the node and summing the results across all properties.

6. The system of claim 5, wherein the initial vector is constructed by concatenating the topology-based component with the node property-based component.

7. The system of claim 1, wherein the processor is configured to use the initial vectors to generate the embeddings at least in part by iteratively averaging, for each node, respective intermediate vectors of neighboring nodes to which the node is connected in the graph by a relationship.

8. The system of claim 7, wherein for each node the embedding comprises a weighted sum of the respective results of the iterative averaging.

9. The system of claim 1, wherein the processor is further configured to use the embeddings as input to a machine learning process.

10. The system of claim 9, wherein the machine learning process generates a model.

11. The system of claim 10, wherein the graph comprises a first graph and wherein the processor is configured to use the model to make a prediction with respect to a second graph.

12. The system of claim 11, wherein the second graph comprises a set of nodes having node property values that correspond to the set of node properties used to generate a model using the first graph.

13. The system of claim 1, wherein the processor is further configured to store the embedding generated for each node in the graph as a node property of the node.

14. A method, comprising:
storing graph data comprising a plurality of nodes, each of at least a subset of nodes having associated therewith a set of one or more node property values, wherein each node represents an entity and each of the one or more node property values includes information about the entity of a corresponding node;
generating for each node in at least said subset of nodes an initial vector based at least in part on the set of one or more node property values; and
using the initial vectors to generate for each node in at least said subset of nodes an embedding, wherein the embedding encodes information about the corresponding node in a vector.

15. The method of claim 14, wherein the initial vector includes a topology-based component and a node property-based component.

16. The method of claim 15, wherein the topology-based component comprises a very sparse random vector.

17. The method of claim 15, wherein the node property-based component is constructed at least in part by initializing a very sparse random vector for each node property corresponding to said one or more node property values; and, for each node, combining the very sparse random vector initialized for each property with the corresponding node property values for the node.

18. The method of claim 17, wherein combining includes for each property multiplying the per property very sparse random vector by the corresponding node property value for the node and summing the results across all properties.

19. The method of claim 18, wherein the initial vector is constructed by concatenating the topology-based component with the node property-based component.

20. A computer program product embodied in a non-transitory computer readable medium, comprising computer instructions for:
storing graph data comprising a plurality of nodes, each of at least a subset of nodes having associated therewith a set of one or more node property values, wherein each node represents an entity and each of the one or more node property values includes information about the entity of a corresponding node;
generating for each node in at least said subset of nodes an initial vector based at least in part on the set of one or more node property values; and
using the initial vectors to generate for each node in at least said subset of nodes an embedding, wherein the embedding encodes information about the corresponding node in a vector.
